(19) United States
(12) Patent Application Publication
(10) Pub. No.: US 2007/0068009 A1
(43) Pub. Date: Mar. 29, 2007

(54) BLADE FOR ROTARY CUTTER

(76) Inventor: Barry D. Fenton, Grande Prairie (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/556,122

(22) Filed: Nov. 2, 2006

(30) Foreign Application Priority Data
Sep. 27, 2005 (CA) 2523324

(51) Int. Cl. B26B 9/00

(52) U.S. Cl. 30/347

(57) ABSTRACT

A blade for a rotary cutter includes a rigid body having an attachment end, a cutting end, a first edge and a second edge. A first contact edge is positioned where the first edge meets the cutting end. A second contact edge is positioned where the second edge meets the cutting end. At least two cutting teeth are sequentially spaced along an arcuate cutting path at the cutting end of the body. Each of the cutting teeth strike vegetation sequentially and are sheltered from impact damage by one of the first contact edge or the second contact edge.

### FIELD OF THE INVENTION

The present invention relates to a blade for a rotary cutter used to cut vegetation.

### BACKGROUND OF THE INVENTION

U.S. Pat. No. 5,570,571 (Dallman 1996) entitled “Blade for a flail type brush cutting machine”, discloses one existing type of blade for a rotary cutter.

### SUMMARY OF THE INVENTION

According to the present invention there is provided a blade for a rotary cutter, which includes a rigid body having an attachment end, a cutting end, a first edge and a second edge. Means are provided for attachment to a rotary cutter positioned at the attachment end of the body. A first contact edge is positioned where the first edge meets the cutting end. A second contact edge is positioned where the second edge meets the cutting end. At least two cutting teeth are sequentially spaced along an arcuate cutting path at the cutting end of the body. Each of the cutting teeth strike vegetation sequentially and are sheltered from impact damage by one of the first contact edge or the second contact edge.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of a blade constructed in accordance with the teachings of the present invention.

FIG. 2 is a side elevation view of the blade illustrated in FIG. 1.

FIGS. 3 through 6 are side elevation views of alternatives to the blade illustrated in FIG. 1.

### DETAILED DESCRIPTION OF THE PREFERRED EMBODIMENT

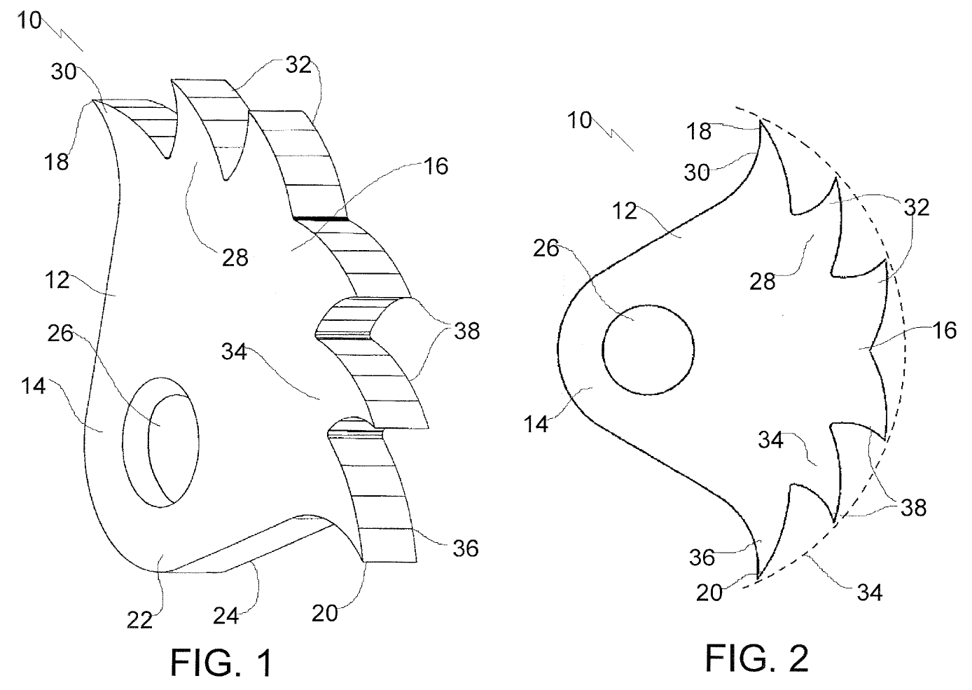

The preferred embodiment, a blade generally identified by reference numeral 10, will now be described with reference to FIGS. 1 and 2.

Structure and Relationship of Parts:

Referring now to FIG. 1, there is shown blade 10, including a rigid body 12 that has an attachment end 14, a cutting end 16, a first edge 18, a second edge 20 and planar opposed faces 22 and 24. A mounting aperture 26 is positioned at attachment end 14 of body 12. Mounting aperture 26 is adapted to permit attachment of body 12 to a rotary cutter (not shown). Referring to FIG. 2, opposite attachment end 14 is a first set of cutting teeth 28 at cutting end 16 of body 12. A first contact edge 30 is formed where first edge 18 meets cutting end 16. In this embodiment first contact edge 30 is in the form of a leading cutting tooth. Two trailing cutting teeth 32 are sequentially spaced from first edge 18 along an arcuate cutting path 34. In this embodiment the arcuate cutting path is defined by a radii extending from mounting aperture 26. There is also a second set of cutting teeth 34 at cutting end 16 of body 12, symmetrical with first set of cutting teeth 28. A second contact edge 36 is formed where second edge 20 meets cutting end 16. In this embodiment, second contact edge 36 is a leading cutting tooth. Two trailing cutting teeth 38 are sequentially spaced from second edge 20 along arcuate cutting path 34.

Operation:

Referring now to FIGS. 1 and 2, the use of blade 10 will now be discussed. Blade 10 provided as describe above. Attachment end 14 is attached to a rotary cutter (not shown) by mounting aperture 26. As vegetation comes within arcuate cutting path 34, leading cutting tooth 30 of first set of cutting teeth 28 first strikes the vegetation, then the trailing cutting teeth 32, causing the vegetation to rip at the points of contact. Once leading cutting tooth 30 and trailing cutting teeth 32 are dulled, blade 10 is removed from the rotary cutter, reversed, and reattached by mounting aperture 26 to continue. Once blade 10 is reversed, leading cutting tooth 36 of second set of cutting teeth 34 first strikes the vegetation, then the trailing cutting teeth 38, causing the vegetation to rip at the points of contact.

Variations:

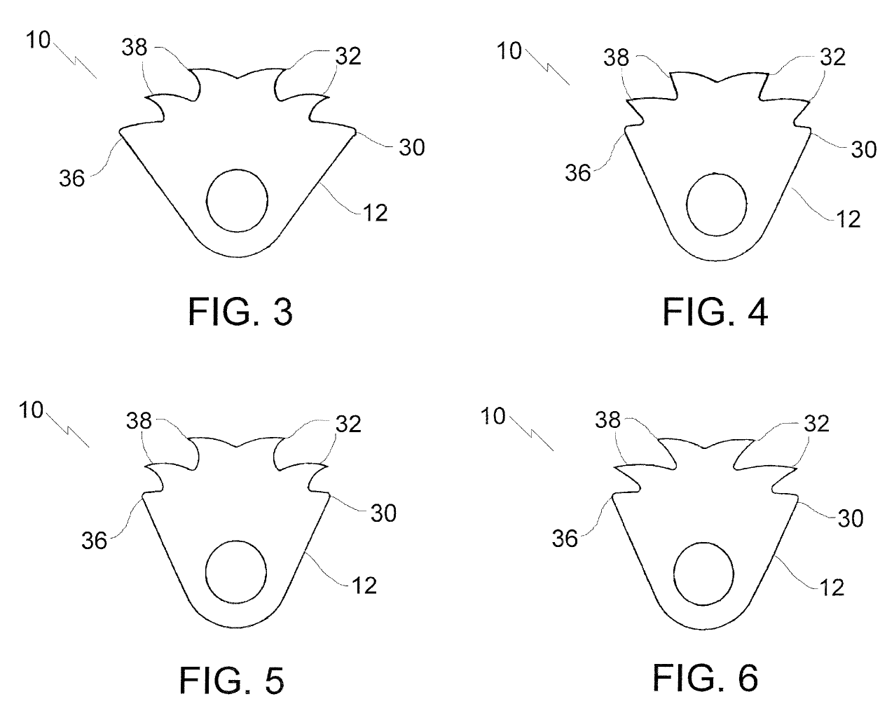

In the embodiment illustrated in FIGS. 1 and 2, first contact edge 30 and second contact edge 36 were made in the form of leading cutting teeth. These teeth would become dulled from impact damage through use over time, but would shelter trailing teeth 32 and 38 from impact damage. Referring to FIGS. 3 through 6, it can be seen that first contact edge 30 and second contact edge 36 need not be leading cutting teeth. They are depicted as being more in the nature of impact shoulders, which are more durable. The cutting function can be assigned primarily to cutting teeth 32 and 38, with first contact edge 30 and second contact edge 36 merely serving to shelter cutting teeth 32 and 38 from impact damage. It can also be seen that the dimensions of first contact edge 30 and second contact edge 36 may be varied from a relatively narrow shoulder as is illustrated in FIG. 4, to a comparatively deep shoulder as illustrated in FIG. 3, or something in between as illustrated in FIGS. 5 and 6. It can also be seen that the shape of cutting teeth may vary, but that cutting teeth 32 will always be in an arcuate configuration so that cutting teeth 32 strike vegetation sequentially and similarly, cutting teeth 38 will always be in an arcuate configuration so that cutting teeth 38 strike vegetation sequentially, depending upon the direction of rotation. The embodiment illustrated in FIGS. 1 and 2, can be said to be in a radial configuration. This cannot be said of the embodiments illustrated in FIGS. 3 through 6. Each embodiment can, however, be said to resemble a “pineapple” with cutting teeth 32 arranged in an arc and cutting teeth 38 arranged in an arc. They are mounted to rotate in one direction. This means that when rotating in a first direction cutting teeth 32 are exposed to vegetation and cutting teeth 38 are sheltered. When cutting teeth 32 become worn, the body is reverse and rotated so that cutting teeth 38 are exposed to vegetation. This aspect of the invention, along with protection from impact damage by first contact edge 30 and second contact edge 36 more than doubles the useful life of the cutting teeth. The size of first contact edge 30 and second contact edge 36 can be altered to vary the performance characteristics of the cutter. For example, one may adopt the embodiment illustrated in FIG. 4, with a larger shoulder, to make body 12 heavier and thus increase the inertia, such that the rotary cutter may be rotated slower. Cutting teeth 32 and 38 may also be varied depending upon the desired uses, for example, referring to FIG. 4, teeth 32 and 38 may have a straight cutting face 40, or, referring to FIG. 6, may have a more angled cutting face 40.

Advantages:

The useful life of this blade is much longer than other cutter configurations. As described above, blade has multiple teeth. The contact edge will unavoidably experience more abuse than the trailing teeth. The cutting teeth are sheltered from striking rocks and experiencing other impacts that the contact edge will experience. When the contact edge is in the form of a leading tooth, this means that even as the leading tooth begins to dull, the trailing teeth will still be performing at a satisfactory level. When the contact edge is in the form of a shoulder, the trailing cutting teeth are also sheltered from impact damage. The cutter is build symmetrically. When the first set of teeth sequentially arranged from the first edge have dulled, the cutter can be inverted and the second set of teeth sequentially arranged from the second edge used.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

What is claimed is:

1. A blade, comprising:
a rigid body having an attachment end, a cutting end, a first edge and a second edge;
means for attachment to a rotary cutter positioned at the attachment end of the body;
a first contact edge where the first edge meets the cutting end;
a second contact edge where the second edge meets the cutting end; and
at least two cutting teeth sequentially spaced along an arcuate cutting path at the cutting end of the body, such that each of the cutting teeth strike vegetation sequentially and are sheltered from impact damage by one of the first contact edge or the second contact edge.

2. The blade as defined in claim 1, wherein the arcuate cutting path is defined by a radii extending from the attachment means.

3. The blade as defined in claim 1, wherein the first contact edge and the second contact edge constitute leading cutting teeth.

4. The blade as defined in claim 1, wherein the body has planar opposed faces.

5. The blade as defined in claim 3, wherein the body is symmetrical with an equal number of cutting teeth sequentially spaced from both the first edge and the second edge of the body.

6. The blade as defined in claim 1, wherein the attachment means is a mounting aperture.

7. A blade, comprising:
a rigid body having an attachment end, a cutting end, a first edge, a second edge and planar opposed faces;
a mounting aperture positioned at the attachment end of the body adapted to permit attachment of the body to a rotary cutter;
a first set of cutting teeth at the cutting end of the body including a leading cutting tooth formed as a first contact edge where the first edge meets the cutting end and two trailing cutting teeth sequentially spaced from the first edge along a radial cutting path as defined by a radii extending from the mounting aperture; and
a second set of cutting teeth at the cutting end of the body including a leading cutting tooth formed as a second contact edge where the second edge meets the cutting end and two trailing cutting teeth sequentially spaced from the second edge along a radial cutting path as defined by a radii extending from the mounting aperture.

8. A blade, comprising:
a rigid body having an attachment end, a cutting end, a first edge, a second edge and planar opposed faces;
a mounting aperture positioned at the attachment end of the body adapted to permit attachment of the body to a rotary cutter;
a first contact edge where the first edge meets the cutting end;
a second contact edge where the second edge meets the cutting end; and
a first set of cutting teeth at the cutting end of the body sequentially spaced from the first edge along an arcuate cutting path, such that each of the cutting teeth strike vegetation sequentially and are sheltered from impact damage by the first contact edge; and
a second set of cutting teeth at the cutting end of the body sequentially spaced from the second edge along an arcuate cutting path, such that each of the cutting teeth strike vegetation sequentially and are sheltered from impact damage by the second contact edge.
